(19) United States
(12) Patent Application Publication
(10) Pub. No.: US 2025/0043171 A1
(43) Pub. Date: Feb. 6, 2025

(54) POLYMERIC GELS WITH ORGANIC CROSSLINKERS FOR WATER BLOCKING IN OIL WELLS AND THEIR SYNTHESIS PROCESS

(71) Applicant: Instituto Mexicano del Petróleo, Mexico City (MX)

(72) Inventors: Natalya Victorovna Likhanova, Mexico City (MX); Diego Javier Guzmán Lucero, Mexico City (MX); Dennys Armando López Falcón, Mexico City (MX); Javier Guzmán Pantoja, Mexico City (MX); Araceli Vega Paz, Mexico City (MX); Jorge Froylán Palomeque Santiago, Mexico City (MX); Silvia Castillo Acosta, Mexico City (MX); Felipe de Jesús Guevara Rodríguez, Mexico City (MX); Rafael Martínez Palou, Mexico City (MX); Sandra Valeria Velázquez Pineda, Mexico City (MX)

(21) Appl. No.: 18/788,859

(22) Filed: Jul. 30, 2024

(30) Foreign Application Priority Data
Jul. 31, 2023 (MX) MX/A/2023/009021

(51) Int. Cl. C09K 8/588; C09K 8/508

(52) U.S. Cl. CPC C09K 8/588; C09K 8/5083

(57) ABSTRACT

The present disclosure relates with the development of a process for producing gels from polymeric materials crosslinked with organic agents and their use controlling water in porous media under high salinity and temperature conditions. The characteristics of these gels enable them to have a good performance withstanding extreme conditions in mature Mexican oil wells and in others located in other parts of the world. The gels featured in the present disclosure include novel ionic terpolymers based on acrylamide (AM), N-vinylpyrrolidone (VP), N,N′-methylenebisacrylamide (BAA), 1-vinyl-3-butylimidazolium bromide (VIM4C[Br]) and organic crosslinking agents.

### CROSS-REFERENCE TO RELATED APPLICATIONS

This patent application claims priority under 35 U.S.C. Section 119 to Mexican Patent Application No. MX/a/2023/009021, filed Jul. 31, 2023, the entire disclosure of which is incorporated herein by reference.

### FIELD

The present disclosure relates to the preparation process of gels from novel ionic terpolymers through their crosslinking with organic agents and to their efficient use to control effectively water in porous media that represent the production zone of an oil well under simultaneous extreme salinity and temperature conditions.

### BACKGROUND

The recovery of big hydrocarbon amounts from mature oil wells is the main goal of the Enhanced Oil Recovery (EOR). The presence of excessive amounts of water in these wells is the main obstacle for oil extraction from mature reservoirs [Tongwa, P., Baojun, B. J. Pet. Explor. Prod. Technol. 2014, 5, 201].

Chemical methods have been the most studied to control water and among them, the treatment with gellified polymers is one of the most frequently employed alternatives for reducing the excessive production of water through the reduction of the reservoir heterogeneity [Zhu, D. et al. E & F 2017, 31, 13063-13087]. Up to now most of the gels used for this purpose are obtained from polymers based on polyacrylamide (PAM) or polysaccharides [Bai, B. et al. 2015, 42, 525-532; Alquraishi, A. A., Alsewailem, F. D. Carbohydr. Polym. 2012, 88, 859; U.S. Pat. No. 4,605,689 (1986)]. Crosslinking can be carried out through metal inorganic compounds or organic crosslinking agents [A. A. Alquraishi and F. D. Alsewailem, Carbohydr. Polym. 2012, 88, 859; Amir, Z., et al. Polym. Adv. Technol. 2019, 30. 13-39; Aldefetah Ghriga, M., et al. Pollym. Bull. 2019, doi: 101007/s00289-019]. Notwithstanding most of these crosslinked polymer gels still display gelling times, thermal instability and salt tolerance that are inappropriate for the effective control of water in oil production wells. Despite the great advance achieved in the development and structural modification of polymers and their gels for controlling water in mature wells, currently, the synthesis of polymers that can be environmentally friendly and capable of withstanding both extreme salinity and temperature conditions, like those present in many mature wells in Mexico and other countries, continues being a big challenge.

Under extreme conditions, polymers undergo different phenomena such as hydrolysis, syneresis and precipitation, which cause degradation and low performance. U.S. Pat. No. 4,095,651 (1975)] deals with the use of hydrolyzed polyacrylamide. This type of polymers is more effective in water with low salt content, being quickly degraded as the salt amount grows. In the presence of polyvalent ions, these polymers tend to form precipitates at high temperatures that can block the pores of formation rocks.

U.S. Pat. No. 4,842,071 (2002) describes the application of acrylamide polymers or non-hydrolyzed-acrylamide copolymers that are hydrolyzed by the further introduction of a basic aqueous solution. However, this method has disadvantages due to the use of an additional solution, accessibility problems of the injected polymer solution and corrosion that is triggered by the employment of alkaline dissolutions.

Many hydrosoluble non-crosslinked polymers for controlling water in porous media at well or reservoir level have been patented. U.S. Pat. No. 4,069,161 (1978) describes the synthesis and use of aqueous dissolutions through their freezing and grinding. The particles obtained at the mill output are easily dissolved in water, forming a homogeneous solution that results efficient for the control of water in porous media.

U.S. Pat. No. 4,718,491 (1985) deals with the injection of a polysaccharide aqueous dispersion for reducing or stop completely water from flowing from a formation into a production well without diminishing its oil and gas production. This process is useful when the well temperature ranges from 70 to 130° C. and/or the salt content is of at least 30 g/L.

U.S. Pat. No. 7,084,094 (2006) describes a polymer for controlling water through permeability reduction in wells by means of an aqueous solution consisting of a water soluble polymer containing from 0.01 to 7.5 mol % of carboxylate groups and with molecular weight ranging from 250,000 to 12,000,000 and phosphonate-based crosslinkers.

In Mexican patent application MX 2017013957 A, Diego Javier Guzmán Lucero et al., published on May 1, 2019, describe a novel family of terpolymers involving partially hydrolyzed polyacrylamides, polyvinyl pyrrolidone and ionic liquids featuring high stability when exposed to high temperatures (150° C.) and high concentration of dissolved salts (250,000 ppm) in the evaluation brine.

U.S. Pat. No. 4,683,949 (1984) deals with the application of a gel based on a polyacrylamide crosslinked with chromium acetate (III). This gel, in addition to feature high toxicity, lowers its performance in high permeability zones and at temperatures above 160° C.

U.S. Pat. No. 4,507,440 (1985) water soluble polymers are studied, consisting of acrylamide copolymerized with formylamido-type monomers under highly acid conditions. The copolymers 2-acrylamido-2-methylpropanesulfonic with N-vinyl-N-methylacetamide and acrylic-vinyl formamide-vinyl pyrrolidone acid contain a —NRₓ—CH═N—CO— bridge. The crosslinked gels are stable at 20-30° C. in acid medium, but are easily hydrolyzed at 80-90° C.

U.S. Pat. No. 4,782,900 de Pfizer (1987) describes the preparation and use of water-based gels of crosslinked aminoalkylated polyacrylamides with aldehydes employed to control water.

U.S. Pat. No. 4,799,548 (1989) deals with two gels obtained from a polyacrylamide polymer and crosslinkers based on an aldehyde and a phenolic compound at different ratios for controlling water in heavy-crude-oil wells. These gels can alter the permeability in wells with temperatures up to 175° F. (74° C.).

U.S. Pat. No. 4,994,194 (1991) describes a gel consisting of a polymer based on polyacrylamide, N-vinylpyrrolidone and a crosslinker containing a mixture of an aldehyde and a salicylic acid derivative like formaldehyde-salicylamide, capable of modifying the permeability of high temperature underground formations. The performance examples of these gels were carried out at temperatures between 200-300° F. (93-149° C.).

U.S. Pat. No. 5,043,364 (1991) relates to the retarded gelation of polymers with novel composition based on acrylamide with furfuryl alcohol and a water soluble aldehyde; the obtained gel has high thermal stability at 300° F. (149° C.).

European patent application EP 2,126,016 A2 (2007) deals with an aqueous mixture based on an organic liquid miscible in water and a synthetic polymer; optionally, a crosslinking agent is added to form a gel in situ. This patent is associated with thermally stable insulating fluids for keeping the oil temperature within the extraction pipe so that it is hot when reaching the surface.

International patent application published as WO 2001,049,971 A1 (2000) describes a method for water blocking using copolymers consisting of structural units of vinyl phosphonic acid, acrylamide and, if necessary, also AMPS and N-vinylformamide, and that can be crosslinked with zirconium compounds. The amount of crosslinkable phosphonic acid and carboxyl groups should range from 0.01 to 7.5 mol %. These polymers were evaluated at 70° C. and 40,000 ppm of salts.

U.S. Pat. No. 8,450,252 B2 (2009) describes an aqueous-based fluid and a reaction product with a gelling agent consisting of a copolymer or a salt of N-[tris(hydroxymethyl)methyl] acrylamide, 2-acrylamido-2-methylpropanesulfonic acid, acrylamide and a crosslinking agent are described. Such fluids are particularly suitable for high temperature applications up to 400° F. (204° C.).

In Canadian patent CA 2,912,418 C (2013), the use of a polymer crosslinked with a monomeric unit consisting of one or more N-vinyl lactams, divinylbenzene, 1,3-divinylimidazolidin-2-one, divinyltetrahydropyrimidin-2 (1H)-one, dienes, allylamines, N-vinyl-3 (E)ethylidenepyrrolidone, ethylidenebis(N-vinylpyrrolidone), and combinations of any of the previous compounds and a crosslinker is stated. The crosslinked polymer can feature additionally a second monomeric unit selected from the following groups: acrylamide, N-substituted acrylamides, methacrylamide, N-substituted methacrylamides, acrylates, methacrylates, acrylic acid, methacrylic acid, N-vinylamides, N-alylamides, vinyl alcohol, vinyl ethers, vinyl esters, allyl alcohol, allyl ethers, allyl esters, vinylpyridine, vinyl sulfonates, allyl sulfonates, vinylimidazole, allylimidazole, diallyldimethylammonium chloride and combinations of any of the previous compounds. It is expected that the polymers be employed at temperatures up to approximately 260° C.

Chinese patent CN 104,629,699 B (2015) offers a type of frozen glue that can withstand salt and temperature. The composition consists of acrylamide/2-acrylamido-2-methylpropanesulfonic acid, resorcinol, polyethylenimine, meta-formaldehyde, alkoxysilane and thiocarbamide. The composition is exposed to salinity of 224,000 ppm with calcium ions and magnesium of 13,000 ppm. This gel can last 100 days without undergoing aging phenomena at 130° C.

U.S. Pat. No. 10,144,866 B2 (2016) reports on a crosslinked copolymer integrated by monomeric units of 2-acrylamido-2-methylpropanesulfonic acid, acrylamide and acrylic acid. This gel is used in the treatment of underground formations with temperatures up to 400° F. (204° C.).

Chinese patent CN 109,400,919 B (2018) deals with a polymeric gel that is capable of resisting high temperatures and forming a gel at intermediate and low temperatures, a preparation method and its application. It is represented by a terpolymer consisting of acrylamide-2-methylpropanesulfonic-vinylpyrrolidone, a thermostabilizer, a crosslinker, resorcinol, urotropine and water, where the thermal stabilizer is thiourea and cobalt chloride. The crosslinking agent is chromium acetate or zirconium acetate and can be stabilized for 90 days at 140° C. This polymeric gel can improve notably the crude oil recovery rate.

U.S. Pat. No. 11,149,187 B2 (2019) describes the composition of an organic gel for blocking fluids in naturally fractured carbonated reservoirs under salinity conditions of up to 31,870 ppm of total dissolved solids and temperatures up to 120° C. with the purpose of isolating temporarily deposit areas. The composition can include from 0.3 to 1 wt. % of a copolymer of a tertiary acrylamide-butyl of sulfonic acid and acrylamide and from 0.12 to 0.4 wt. % of phenol and from 0.18 to 0.6 wt. % of hexamethylenetetramine.

In some of the foregoing cases, the polymeric gels reported up to now are capable of withstanding high temperature conditions, but at high concentrations of salts, they degrade quickly. All the described gels and those featured in the disclosures related to this topic are effective controlling well water only at relatively high temperatures or relatively drastic salinity conditions, but not in wells with extreme conditions implying both variables, i.e. with at least 160° C. and 250,000 ppm of total salinity.

### SUMMARY

Considering that currently there is no report on hydrogels based on water-soluble terpolymers capable of withstanding extreme salinity and temperature conditions, the present disclosure intends to protect the preparation and uses of new gelation polymeric formulations for controlling water in the porous media that represent the production zone of oil wells through permeability modification, which are stable for more than two months at high temperatures, at least at 160° C. and 250,000 ppm of salinity, with both conditions simultaneously.

Then, one of the goals of the present disclosure is to provide novel gels consisting of ionic terpolymers based on acrylamide (AM), N-vinylpyrrolidone (VP), N,N′-methylenebisacrylamide (BAA) and 1-vinyl-3-butylimidazolium bromide (VIM4C[Br]) and organic crosslinking agents.

Another additional goal is to offer a chemical process for obtaining polymeric gels with organic crosslinkers featuring three stages: 1. Terpolymer synthesis, 2. Gel formulation and 3. Thermal conditioning in the porous medium for the formation of the rigid gel.

Even another item is to provide an application of the polymeric gels with organic crosslinkers in oil wells under extreme salinity and temperature conditions simultaneously at least at 160° C. and 250,000 ppm of salinity.

### BRIEF DESCRIPTION OF THE DRAWINGS

In order to clarify the description of the polymeric gels with organic crosslinkers for water blocking in a rock porous medium and obtaining process, goals of the present disclosure, the drawings that accompany it will be referred to without limiting the scope of the present disclosure:

FIG. 1 shows the scheme of the terpolymerization reactor through the semi-continuous method for producing the ionic terpolymer [Example 1].

FIG. 2 displays the 1H nuclear magnetic resonance (NMR) of the VIM4C[Br] monomer obtained without purification (4A) and after the purification process [Example 1].

FIG. 3 shows the 1H NMR of the reaction advance in the polymerization systems in a single reactor by the semi-continuous method [Example 1].

FIG. 4 features the polymer infrared spectrum (FTIR) of the ionic terpolymer P (AM-VP-VIM4C[Br]) with BAA obtained by the semi-continuous method [Example 1].

FIG. 5 illustrates the thermogravimetric analyses (TGAs) of the ionic terpolymers P (AM-VP-VIM4C[Br]) with BAA synthesized by the batch and semi-continuous methods [Example 1].

FIG. 6 shows the appearance and viscosity data of the gels with branched polyethyleneimine as crosslinker with intermediate molecular weight (IMW), exposed at 160° C. for a time period spanning up to 72 days [Example 2].

FIG. 7 displays the appearance of the gels with crosslinker hexamethylenetetramine (HMTA) and resorcinol (R) in double-distilled water exposed at 160° C. for a time period of up to 180 days [Example 3].

FIG. 8 shows the gel swelling percentage of dissolution “G” exposed at 160° C. for a time period of up to 180 days [Example 3].

FIG. 9 features the appearance of the gels with crosslinker HMTA and R in brine exposed at 160° C. for a time period of up to 180 days [Example 4].

FIG. 10 illustrates the diagram of the injection system employed in the tests with sandstone rock cores [Example 5].

FIG. 11 exhibits the differential pressure change during the brine injection at a flow rate of 1 mL/h in the Test 1 core at 130° C.: a) dotted black line-core characterization with water; b) solid gray line-gel blocking [Example 5].

FIG. 12 displays the differential pressure change during the brine injection at flow rate of 1 mL/h in the Test 2 core at 130° C.: a) dotted black line-secondary recovery; b) solid gray line-gel blocking [Example 5].

### DETAILED DESCRIPTION

First, the present disclosure refers to the development of hydrogels with organic crosslinkers based on terpolymers derived from AM, N—VP and VIM4C[Br] monomers with BAA crosslinking percentage between 0.01 and 0.1 mol % with respect to the total molar content of AM, N—VP and VIM4C[Br]. The product is obtained through 3 stages:

At the first stage, the polymer is obtained in a single-reactor system (one-pot) in semi-continuous mode.

At the second stage, the formulation of the produced polymer is carried out with the organic crosslinkers to form the gelation system.

At the third stage, the gelation system is exposed to a temperature of 160° C. in order to form the rigid gel, which blocks the pass of fluids in the porous medium, thus performing the efficient water control.

The first stage deals with the synthesis of the terpolymers AM-VP-VIM4C[Br] with BAA in a single reactor by the semi-continuous method, which means that in the same reactor, the monomeric ionic liquid VIM4C[Br] will be obtained through a first reaction (see Scheme 1 that depicts the reaction scheme for producing the vinyl ionic liquid VIM4C[Br]) from N-vinylimidazole and 1-bromoalcane at 35° C. for at least 24 h and afterward, in the same reactor (without carrying out any separation or monomer purification), the terpolymerization reaction goes on in aqueous dissolution by adding the other monomers AM, VP and Ia BAA in aqueous dissolution by semi-continuous reaction and using a molar ratio of AM: VP: VIM4C[Br] of (20-50): (15-40): (10-40), respectively, and a BAA molar percentage between 0.01 and 0.1 mol % for producing the polymer P (AA-VP-VIM4C[Br]) with BAA (see Scheme 2, chemical structure of the ionic terpolymer P (AM-VP-VIM4C[Br]) obtained with BAA).

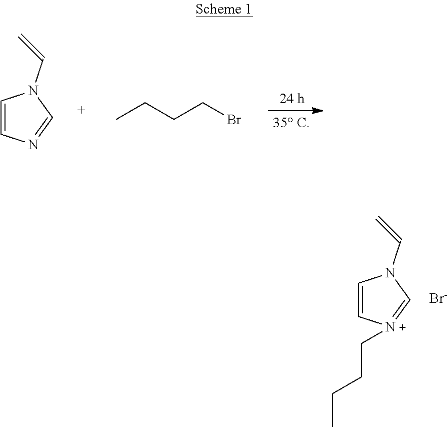

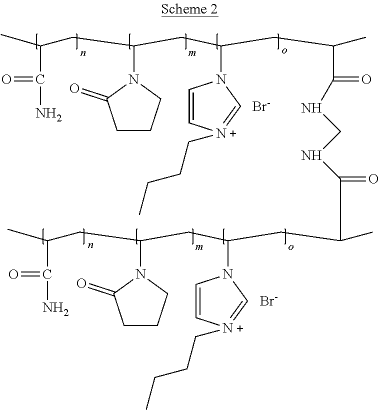

The monomers are polymerized by the free-radical mechanism using polymerization initiators, which can include, but without being limited to initiators such as 2,2′-diamino-2-2′-azodipropane dihydrochloride, ammonium persulfate and potassium persulfates, among others. Among the polymerization techniques that can be used, the following are found: solution polymerization, emulsion polymerization, etc.

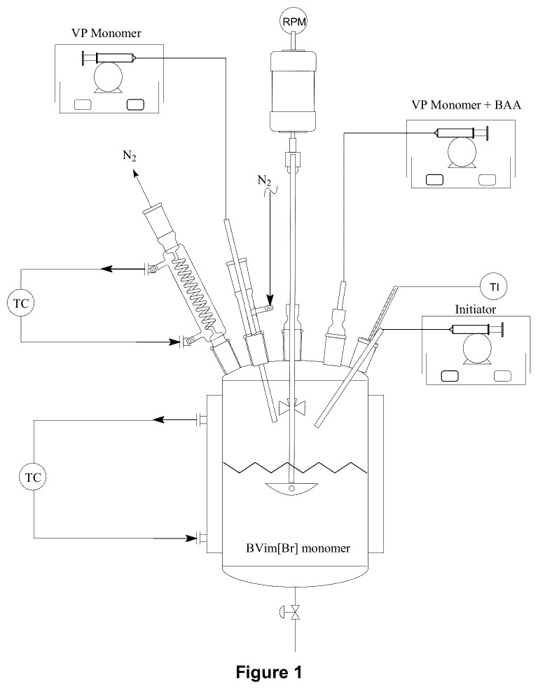

The polymerization technique that was used in the present disclosure was polymerization in aqueous dissolution, without this one being a limitation to employ the other polymerization techniques with vinyl monomers. The copolymerization in aqueous dissolution was carried out employing a reactor in semi-continuous mode at 50° C., ambient pressure for 24 h and in the presence of nitrogen as shown in FIG. 1.

From the polymerization reaction, the conversion percentage p_i(t) of the monomer identified with the subscript “i” is determined. p_i(t) is a function of time that starts with the value 0% and with time reaches the final value of 100%, defining three stages such as: induction, acceleration and saturation. At the induction stage, the monomer conversion rate “i” is low during a short time interval, but always growing. At the end of the induction stage, the monomer conversion rate increases quickly in a short time (accelerated chemical reaction). Finally, the saturation stage is characterized by a conversion rate diminution due mainly to the monomer consumption and increase in the final product viscosity.

By comparing the conversion percentages of the monomers in the chemical reaction, it is found that certain monomers react more quickly than others, e.g. the AM reaction is faster than that of VP. In this example, the condition P_{AM}(t_{AM})=P_{VP}(t_{VP}) establishes that the AM reaction time is shorter than that of VP: t_{AM}<t_{VP}. The reaction rate differences between monomers in the chemical reaction are the origin of the problems for controlling the temperature (in the case of exothermic reactions) and quality of the resulting product. A simple way to solve the problems derived from the direct reaction is by carrying out a controlled reaction, where the monomers are added during the reaction. If Vᵢ(t) is the monomer addition rate “i” at time “t”, then, the new conversion percentage Pᵢ(t) can be estimated with the following expression:

$${P}_{i} ( t ) = {\int }_{0}^{t} {V}_{i} ( τ ) {p}_{i} ( t - τ ) d τ$$

The simplest way to add a component is through the dosing with constant rate, i.e. Vᵢ(t)=xᵢ/Tᵢ, where xᵢ is the final fraction of monomer “i” in the reaction and Tᵢ is the total addition time. By employing the example mentioned above, the condition P_{AM}(t_{f})=P_{VP}(t_{f}) for a time value to close to the end of the chemical reaction allows the estimation of the dosing times TAM and Typ. In this way, the heat generated during the reaction can be controlled by modifying the value of t_{f} whereas the dosing times T_{AM} and T_{VP} allow the possibility of monomers reaching 100% of conversion concurrently and thus increasing the likelihood of having a product with a more homogeneous distribution of the monomers.

The second stage has to do with the formulations of the terpolymers obtained with organic crosslinkers based on: a) PEI at terpolymer/PEI weight ratios of 7-15/1; b) HMTA and R at terpolymer/HMTA/R weight ratios of 2.25/1-0.25/2.5-1.50. The formulations are submitted at temperatures between 120° C. and 170° C. in order to form a rigid gel.

The third stage deals with the tests aiming at blocking the pass of fluids and controlling water in the porous medium, represented by the sandstone rock cores.

In certain aspects, the chemical process for obtaining the gels that are the subject matter of this disclosure can include three stages: 1) terpolymer synthesis, 2) gel formulation and 3) thermal conditioning in a porous medium for the formation of a rigid gel. Once these gelation materials are formulated, the blocking of fluids in a porous medium is carried out for the efficient control of water in this type of complex rock-oil-brine systems.

### Examples

Having described the present disclosure and its characteristics, the following examples are presented with illustrative purposes and not to limit the scope of the present disclosure.

### Example 1. Polymer preparation from acrylamide, N,N′-methylenebisacrylamide, N-vinylpyrrolidone and 1-vinyl-3-butylimidazolium bromide P (AM-VP-VIM4C[Br]

The terpolymerization reaction consists in the synthesis of the ionic monomer, VBIM[Br], as first step and was carried out by the following procedure:
1. The reactions were carried out in a 2-L-4-neck-Kettle-type reactor equipped with a mechanical stirrer.
2. By means of a test tube, 42.4 mL of 1-vinylimidazole were poured into the reactor.
3. The mechanical stirring was started at 90 rpm.
4. A test tube was used to pour 50.4 mL of 1-bromobutane into the reactor.
5. Before starting the heating process, all the reactor necks were sealed.
6. The reactor heating was started until reaching 35° C.
7. The reaction took place under stirring at 35° C. and ambient pressure for 24 h.

The polymer production was performed through the following procedure:
8. The mechanical stirring continued at 90 rpm and 35° C.
9. The reaction mixture was sampled to carry out 1H NMR studies.
10. 490 mL of distilled water were poured into the reactor, where the monomer VIM4C[Br] was formed.
11. Separately, in a 500-mL-two-neck flask, by means of magnetic stirring, 39.9 g of AM and 0.048 g of BAA were thoroughly dissolved in distilled water.
12. Separately, in a 500-mL-two-neck flask, by means of magnetic stirring, 59.2 mL of VP were thoroughly dissolved in distilled water.
13. From the AM and BAA aqueous dissolution, air was eliminated by means of vacuum, which was applied for 10 min. After this time passed by, the dissolution flask was vented with a nitrogen current. Afterward the vacuum valves were closed and the system was set at ambient pressure with nitrogen.
14. The AM aqueous dissolution was loaded in a 500-ml syringe to be later pumped into the reactor.
15. The same procedure described in step 13 was performed for the VP dissolution.
16. The VP aqueous dissolution was loaded in another 500-ml syringe to be later injected into the reactor.
17. From the aqueous dissolution of the VIM4C[Br] monomer, air was eliminated by means of vacuum, which was applied for 15 min, and later, ambient pressure was reestablished by circulating gaseous nitrogen into the reactor. The inlet vacuum valves were closed and the reactor was set under ambient pressure with nitrogen. From this point on, constant nitrogen feed of 1 mL/min was set into the reactor.
18. The dissolution temperature in the three-neck flask was adjusted at 50° C.
19. The reactor instrumentation was performed: a syringe pump for the AM+BAA aqueous dissolution, a syringe pump for the VP aqueous dissolution and a syringe pump for the initiator aqueous dissolution.
20. In a 50-mL-two-neck flask, distilled water was poured; air was eliminated by means of the procedure described in step 13 and the initiator V50 was added.
21. The V50 initiator aqueous dissolution was loaded in a syringe to be pumped into the reactor.
22. The pumping times of the dissolutions were: 240 min for the AM+BAA aqueous dissolution, 200 min for the VP aqueous dissolution and 60 min for the initiator aqueous dissolution.
23. When the temperature of the VIM4C[Br] aqueous dissolution reached 50° C., the simultaneous pumping of the (AA+BAA), VP and V50 initiator aqueous dissolutions was carried out according to the times stated in the previous step.
24. Once the aqueous dissolutions of monomers and initiator are added into the reactor, the reaction is allowed to proceed for 24 h.
25. Once 24 h passed, the reaction mixture was sampled to carry out 1H NMR studies.
26. A new V50 initiator aqueous dissolution was prepared, eliminating air as described in step 13, and transferred to a 20-ml syringe.
27. The previous aqueous dissolution was pumped into the reactor for 30 min.
28. The reaction was allowed to proceed for 2 h.
29. The final reaction dissolution was sampled to carry out 1H NMR studies.
30. Finally the reaction system was turned off, i.e. the nitrogen flow was removed, the reaction dissolution was allowed to reach ambient temperature and the polymer dissolution was poured into a container to be hermetically sealed.
31. From 2 to 5 mL of reaction dissolution were precipitated in acetone to perform NMR, TGA, DSC and viscosimetry studies.

The terpolymerization reactions took place in a system like the one shown in FIG. 1, where air elimination can be done by the system vacuum control. Once air is removed, ambient pressure can be reestablished by the controlled injection of gaseous nitrogen. By means of two syringe pumps, the aqueous dissolutions of V50 initiator and (AA+BAA and VP) monomers were injected.

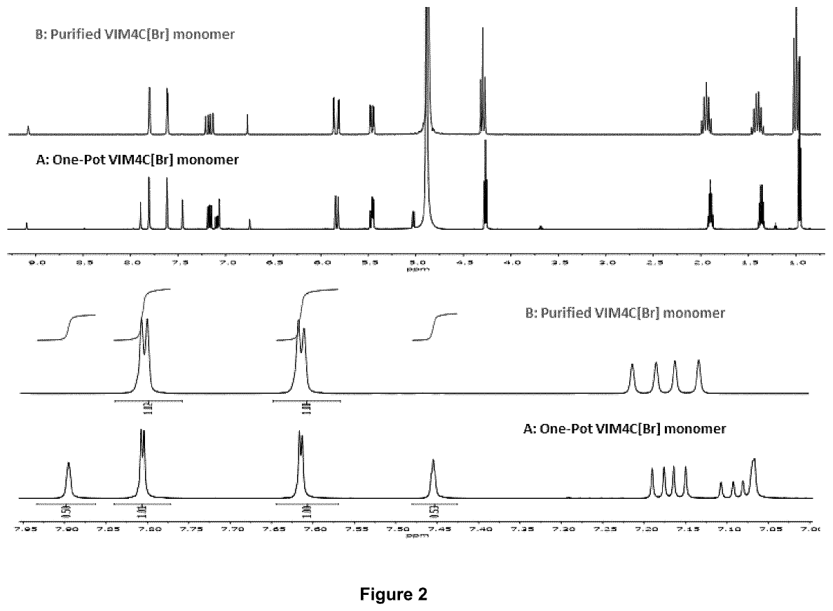

The formation of the monomer and polymer are monitored through 1H NMR and infrared spectroscopy. FIG. 2 shows that the structure of the VIM4C[Br] monomer was obtained by following the reaction evolution in a single reactor (one-pot) (FIG. 2A) and is compared with the 1H NMR of the monomer when purified (FIG. 2B).

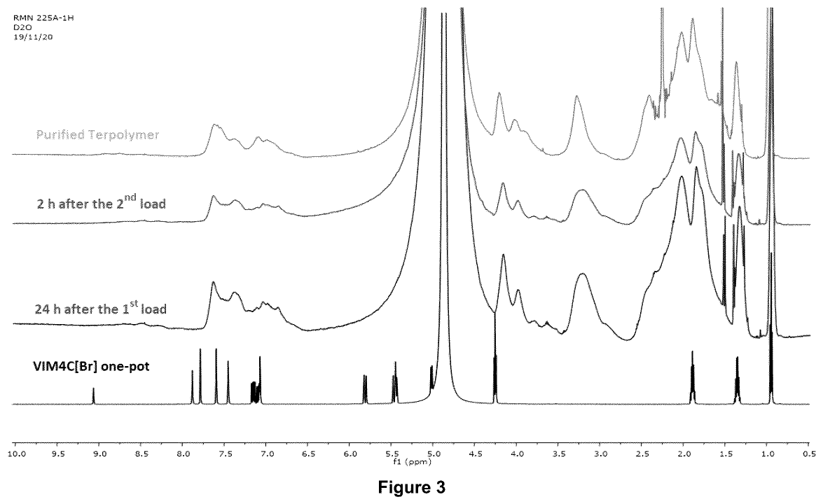

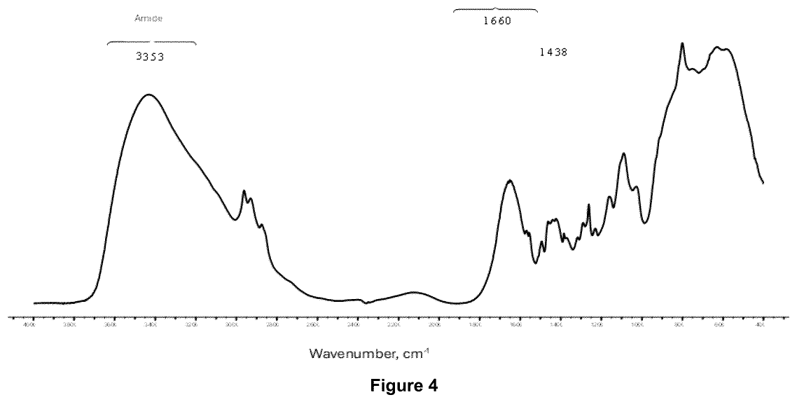

The chemical structure of the polymer was established by 1H NMR in FIG. 3, where the signals of the terpolymers are compared at the different addition times of the monomers and final purified terpolymer. FIG. 4 shows the polymer infrared spectrum of the ionic terpolymer P (AM-VP-VIM4C[Br]) with BAA obtained by the semi-continuous method.

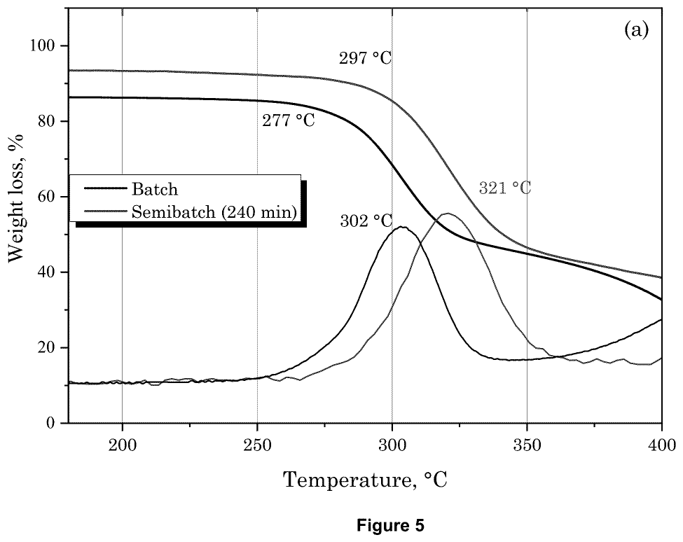

FIG. 5 displays the thermogravimetric analyses of P (AM-VP-VIM4C[Br]) with BAA, where the terpolymer obtained by the semi-continuous method is compared with the terpolymer produced in a batch process. The thermal resistance of the polymer produced in a semi-continuous reaction system is considerably higher.

### Example 2. Preparation of Gels Based on Terpolymer and PEI

A dissolution at 3 wt. % equivalent to the P (AM-VP-VIM4C[Br]) terpolymer with BAA was prepared by using the product without purification obtained at point 30 of Example 1 and a synthetic brine with 250,000 ppm of total dissolved solids consisting of 150,000 ppm of sodium chloride and 100,000 ppm of calcium chloride. The mixture was dissolved and homogenized by means of a mechanical stirrer at 150 rpm for 12 h; it was labeled as dissolution A.

Likewise, a PEI dissolution at 1 wt. % was prepared with synthetic brine at 250,000 ppm of total dissolved solids consisting of 150,000 ppm of sodium chloride and 100,000 ppm of calcium chloride. The mixture was dissolved and homogenized by mechanical stirring at 150 rpm for 12 h; it was labeled as dissolution B.

To 20 mL of dissolution A, 5 mL of dissolution B were added and this mixture was adjusted with the 0.1 M dissolution of hydrochloric acid at pH 6.5. It was labeled as dissolution C.

In order to carry out the isothermal tests, 20-mL aliquots of dissolution C were taken and placed in quartz vials for high temperature and pressure; oxygen dissolved in the dissolution was displaced by circulating nitrogen for 20 min; afterward, the vials were hermetically sealed and placed in a stove with holding and sealing system to be kept at constant temperature of 160° C. for the defined time. To perform the isothermal tests, 20-mL aliquots of dissolution C were

taken. The tracking was carried out from day 1 to day 72; the corresponding vial was removed from the stove, keeping the hermetical sealing, and let to cool down at ambient temperature. Afterward, the viscosity measurement was performed in a concentric cylinder rheometer under the following conditions: sheer rate from 0.1 to 1000 s⁻¹, number of points equal to 1000 and 30° C.

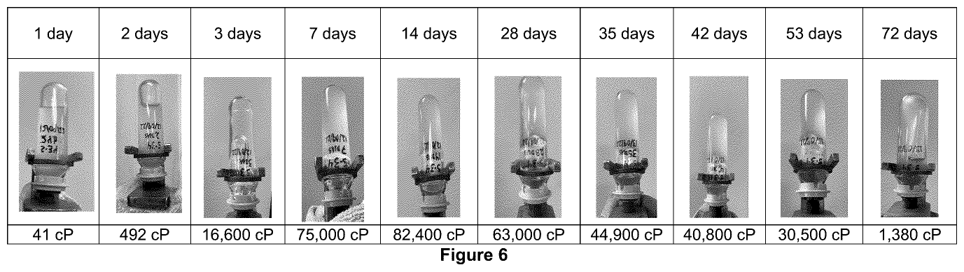

FIG. 6 depicts the formation of the yellowish, transparent gels with PEI crosslinker at 160° C.

It was noticed that from the third day, a rigid gel was formed, reaching its maximal viscosity equivalent to 82400 cP by the fourteenth day. The viscosity of the formed gel diminished gradually from the fourteenth day until 1380 cP by day 72. The gel kept its rigid form for 72 days at 160° C. in brine at 250,000 ppm.

### Example 3. Preparation of Gels Based on Terpolymer and Crosslinkers HMTA and Resorcinol (R) in Distilled Water

A dissolution at 1 wt. % equivalent to the terpolymer P (AM-VP-VIM4C[Br]) with BAA was prepared by using the product obtained in point 30 from Example 1 without purification and distilled water. The mixture was dissolved and homogenized by means of a mechanical stirrer at 150 rpm for 12 h; it was labeled as dissolution D.

Likewise, an HMTA dissolution at 10 wt. % with distilled water was prepared; it was dissolved and homogenized by using a mechanical stirrer at 150 rpm for 12 h; it was labeled as dissolution E.

Separately, dissolution R was prepared at 10 wt. % with distilled water; the mixture was dissolved and homogenized by means of a mechanical stirrer at 150 rpm for 12 h; it was labeled as dissolution F.

To 8.7 mL of dissolution D, 0.4 mL of dissolution E and 0.9 mL of dissolution F were added; it was labeled as dissolution G.

To 8.7 mL of dissolution D, 0.4 mL of dissolution E and 1 mL of dissolution F were added; it was labeled as dissolution H.

To 8.7 mL of dissolution D, 0.4 mL of dissolution E and 0.7 mL of dissolution F were added, it was labeled as dissolution I.

In order to perform the isothermal tests, 20-mL aliquots of dissolutions G, H and I were taken separately and placed in vials for high temperature and pressure; oxygen dissolved in the dissolution was displaced by circulating nitrogen for 20 min; afterward, the vials were hermetically sealed and placed in a stove with holding and sealing system to be kept at constant temperature of 160° C. for 180 days. The gels formed with 0.9 mL of R showed higher stability as time passed by than the gels with 0.7 and 1 mL of R.

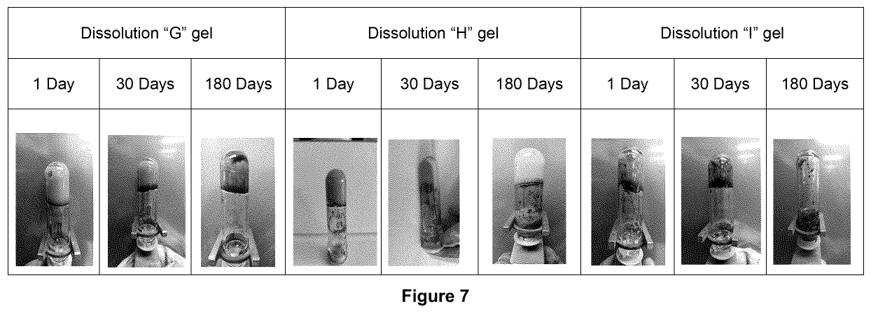

The tracking was performed from day 1 up to day 180. The corresponding vials were removed from the stove, keeping the hermetic seal, and let to cool down at ambient temperature (FIG. 7).

Then, the swelling degree of the formed gel was measured and in order to do so, a portion of the gel removed from the stove was taken and weighed and afterward, it was placed in a stove in vacuum at 90° C. for 20 h; once constant weight was reached, the remnant was weighed again and the swelling percentage was calculated by means of Equation 1:

$$swelling percentage = \frac{P h - P s}{P s} ( 100 \% ) \qquad ( 1 )$$

where Ph=wet gel weight; Ps=dry gel weight.

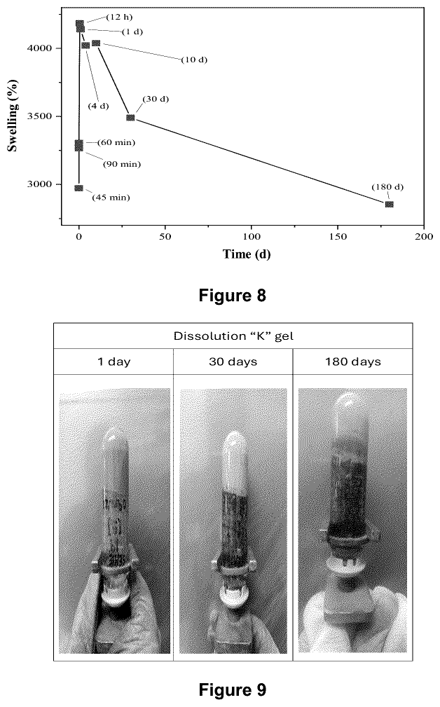

FIG. 8 displays the swelling percentage of the dissolution G gel at 160° C. for a time period of up to 180 days. The swelling percentage achieved its maximal point after 12 h at 160° C. The formed gel lost around 40% of water after 180 days of being exposed at such temperature.

### Example 4. Preparation of Gels Based on Terpolymer and Crosslinkers HMTA and Resorcinol (R) in Brine

A dissolution at 1 wt. % equivalent to the P (AM-VP-VIM4C[Br]) terpolymer with BAA was prepared by using the product without purification obtained at point 30 of Example 1 and a synthetic brine with 250,000 ppm of total dissolved solids consisting of 150,000 ppm of sodium chloride and 100,000 ppm of calcium chloride. The mixture was dissolved and homogenized by means of a mechanical stirrer at 150 rpm for 12 h; it was labeled as dissolution J.

To 8.7 mL of dissolution J, 0.4 mL of dissolution E, 0.9 mL of dissolution F and 0.1 mL of ethanolamine were added; it was labeled as dissolution K.

To carry out the isothermal tests, 20-mL aliquots of dissolution K were taken separately and placed in vials for high temperature and pressure; oxygen dissolved in the dissolution was displaced by circulating nitrogen for 20 min; afterward, the vials were hermetically sealed and placed in a stove with holding and sealing system to be kept at constant temperature of 160° C. for 180 days. The tracking was performed from day 1 up to day 180. The corresponding vials were removed from the stove, keeping the hermetic seal, and let to cool down at ambient temperature (FIG. 9 shows the appearance of the gels with crosslinkers HMTA and R in brine at 160° C.).

The gels based on terpolymer, crosslinkers HMTA and R, and brine were stable for 180 days at 160° C., keeping the appearance of a rigid gel.

### Example 5. Evaluation of the Formed Gels in Berea Sandstone Rock Cores

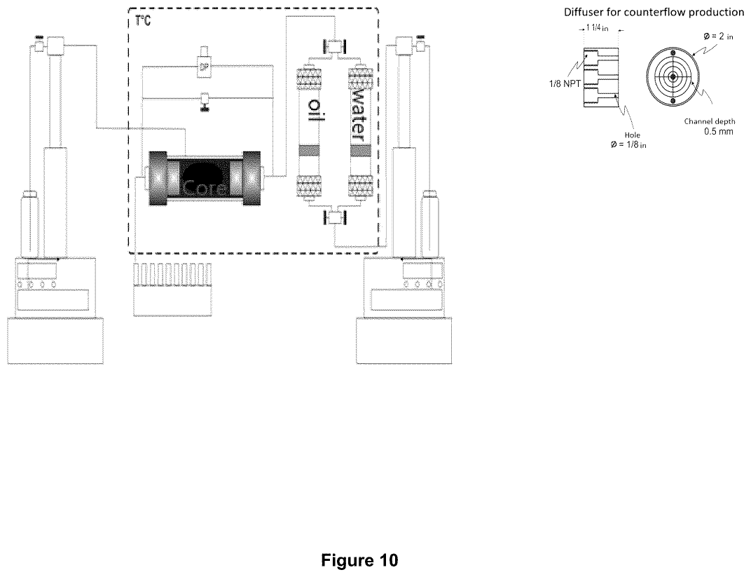

The tests were carried out at 130° C. with confinement pressure of 20.68 Mpa. Once the cores went through the characterization process, they were fractured and characterized for a second time; afterward, the brine saturation was performed. For Test 1, the gelation dissolution of formulation K with viscosity of 8 cP was employed; the core was aged for 18 h at 130° C. in order to finish the crosslinking process and formation of a rigid gel in situ in the porous medium. For Test 2, the core was saturated with oil with 19.6° API (at 16° C.), which was set at 130° C. and oil was displaced by injecting brine until oil production was zero; then, like in Test 1, the gelation dissolution of formulation K was used; the core was aged for 18 h at 130° C. to finish the crosslinking process and form a rigid gel in situ in the porous medium. In both tests, the cores were placed horizontally in the injection system, employing a core holder. The gelation system and fluids (water or brine) were injected through the diffuser from the inlet face and recovered at the outlet face through the recollection system of fluids, measuring the core inlet and outlet pressures (pressure differential) (FIG. 10). In total, 2 tests placing the gel in a porous medium represented by fractured Berea sandstone rock were run: 1) without oil saturation, 2) with oil saturation.

After the exposure for 18 h at 130° C., the injection of brine was started. The characterization data of the porous media are displayed in Table 1.

TABLE 1
Characteristics of the Berea rock porous
media with longitudinal fracture.

| | Test 1 | Test 2 |
|---|---|---|
| Characteristics | (without oil) | (with oil) |
| Diameter, cm | 5.04 | 5.04 |
| Length, cm | 12.38 | 12.40 |
| Permeability (before/after fracture), mD | 48.91/147.34 | 155.46/240.95 |
| Initial porosity, % | 21.38 | 20.32 |
| Porous volume (PV), mL | 52.77 | 50.15 |

The experiment consisted in measuring the pressure differential between both core ends reached by the presence of the gel in situ in the porous medium when brine was injected at different flow rates. Based on the results of this experiment, the percentage of water control efficiency (% E) was calculated, which is defined as follows:

$$\% E = ( Δ {P}_{water with gel placed i n situ} - Δ {P}_{agua} ) * 100 / Δ {P}_{water with gel placed i n situ}$$

where ΔP is the pressure differential reached by the interest fluid once it has broken into and flow stationary conditions through the capillary or porous medium have been achieved.

The brine flow rates selected for Test 1 were 10, 5, 2.5 and 1 cm³/h, whereas for Test 2, the brine injection flow rate was 1 cm³/h.

In Test 1, the brine injection flow rates during the characterization process of the fractured core were 60, 120 and 180 cm³/h, whereas the brine injection flow rates employed during the displacement process ranged from 1 to 10 cm³/h; due to the foregoing, the extrapolation of the pressure differential of the core characterization process had to be done.

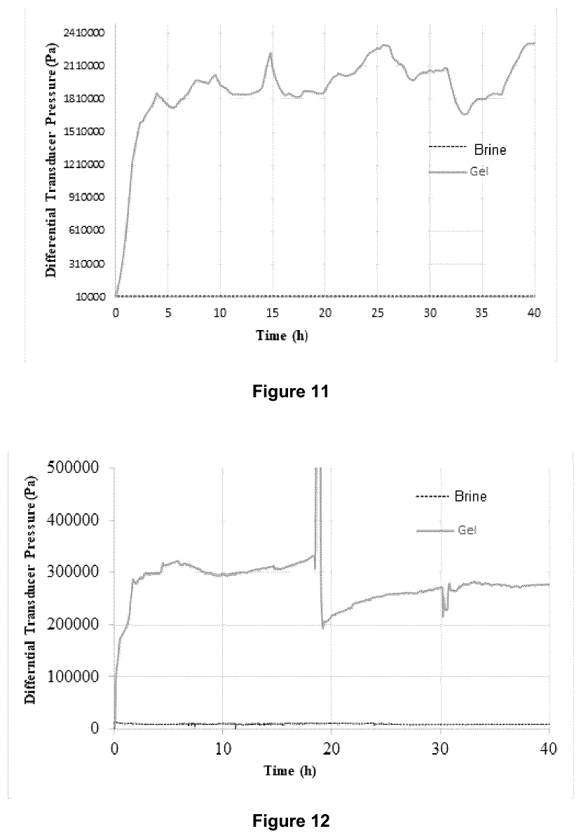

In the case of Test 1, % E was 98.9%, revealing high gel resistance to the brine flow in the fractured porous medium. During the brine injection into the core saturated with gel, it was necessary to diminish the injection flow rates (in the first 2.4 h) from 10 a 1 cm³/h due to the increase in the pressure differential up to the detection limit. Finally, the brine injection was stabilized at flow rate equivalent to 1 cm³/h and was kept injecting for 50 h (FIG. 11 displays the behavior pattern of the differential pressure during the injection of the displacement fluid (brine) at different flow rates into the sandstone rock cores) with pressure difference around 2.068 Mpa.

In the case of Test 2 (FIG. 12 shows the differential pressure change during the injection of brine at 1 mL/h). FIG. 12 exhibits the behavior pattern of the differential pressure during the brine injection at 130° C.: a) dotted black line-secondary recovery; b) solid grey line-gel blocking with pressure difference around 300 Mpa.

The % E values for water control for Test 1 was 98.9% and for Test 2, it was 96.5%.

1. A polymeric gel with organic crosslinkers for blocking water in oil wells, the polymeric gel comprising a terpolymer comprising acrylamide (20-50 mol %), N-vinylpyrrolidone (15-40 mol %), 1-vinyl-3-butylimidazolium bromide (10-40 mol %), and N,N′-methylenebisacrylamide (from 0.01 to 0.1 mol %), and having a structural formula as follows:

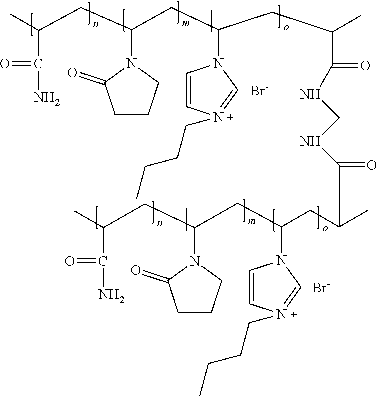

2. The polymeric gel according to claim 1, wherein the polymeric gel comprises a crosslinking agent branched polyethylenimine with intermediate molecular weight with terpolymer/polyethylenimine weight ratios equal to 7-15/1 and a synthetic brine with 250,000 ppm of total dissolved solids constituted by 150,000 ppm of sodium chloride and 100,000 ppm of calcium chloride.

3. The polymeric gel according to claim 1, wherein the polymeric gel comprises a system of crosslinker agents hexamethylenetetramine (HMTA) and resorcinol (R) at the terpolymer/hexamethylenetetramine/resorcinol weight ratios equal to 2.25/1-0.25/2.5-1.50.

4. The polymeric gel according to claim 1, wherein the polymeric gel comprises a system of crosslinker agents hexamethylenetetramine (HMTA), resorcinol (R) and ethanolamine (EA) at terpolymer/hexamethylenetetramine/resorcinol/ethanolamine weight ratios equal to 2.25/1-0.25/2.50-1.50/0.50-2.0 and synthetic brine with total dissolved solids between 50,000-250,000 ppm comprising 0-150,000 ppm of sodium chloride and 0-100,000 ppm of calcium chloride.

5. The polymeric gel according to claim 2, wherein the polymeric gel exhibits resistance to thermal decomposing within a temperature interval ranging from 120° C. to 170° C. for at least 72 days.

6. The polymeric gel according to claim 3, wherein the polymeric gel exhibits resistance to thermal decomposing within a temperature interval ranging from 120° C. to 170° C. for at least 180 days.

7. The polymeric gel according to claim 4, wherein the polymeric gel exhibits resistance to thermal decomposing within a temperature interval ranging from 120° C. to 170° C. for at least 180 days.

8. A method for blocking water in a fractured porous medium, the method comprising providing a polymeric gel according to claim 1 and using it to block water in a fractured porous medium, wherein the polymeric gel exhibits resistance to thermal decomposing within a temperature interval from 120° C. to 170° C. for at least 180 days under salinity conditions from 0 to 250,000 ppm of total dissolved solids.

9. The method according to claim 8, wherein the polymeric gel comprises a crosslinking agent branched polyethylenimine with intermediate molecular weight with terpolymer/polyethylenimine weight ratios equal to 7-15/1 and a synthetic brine with 250,000 ppm of total dissolved solids constituted by 150,000 ppm of sodium chloride and 100,000 ppm of calcium chloride.

10. The method according to claim 8, wherein the polymeric gel comprises a system 8f crosslinker agents hexamethylenetetramine (HMTA) and resorcinol (R) at the terpolymer/hexamethylenetetramine/resorcinol weight ratios equal to 2.25/1-0.25/2.5-1.50.

11. The method according to claim 8, wherein the polymeric gel comprises a system of crosslinker agents hexamethylenetetramine (HMTA), resorcinol (R) and ethanolamine (EA) at terpolymer/hexamethylenetetramine/resorcinol/ethanolamine weight ratios equal to 2.25/1-0.25/2.50-1.50/0.50-2.0 and synthetic brine with total dissolved solids between 50,000-250,000 ppm comprising 0-150,000 ppm of sodium chloride and 0-100,000 ppm of calcium chloride.

12. The method according to claim 8, where polymeric gel blocks fluids in a fractured porous medium with up to 96% of original fluid reduction.

13. A process for producing polymeric gels with organic crosslinking agents according to claim 1, the process comprising performing the following synthesis scheme:

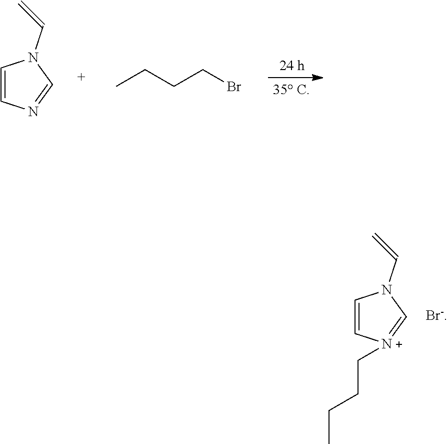

14. The process according to claim 13, wherein the process comprises performing the following stages: (a) stage 1 comprising polymer synthesis in a single reactor in semi-continuous mode to produce a polymer; (b) stage 2 comprising formulation of the polymer obtained at stage 1 with organic crosslinkers to form a gelation system; and (c) stage 3 comprising setting of the gelation system at 160° C. until forming a rigid gel for water control.

15. The process according to claim 13, wherein stage 1 comprises: (a) carrying out in the same reactor a first reaction with the monomeric ionic liquid VIM4C[Br] from N-vinylimidazole and 1-bromoalcane at 35° C. for at least 24 h; (b) afterward, in the same reactor, continuing the terpolymerization reaction in aqueous dissolution by adding the monomers AM, VP and BAA in aqueous dissolution by the semi-continuous method, employing an initial molar ratio of AM: VP: VIM4C[Br] of (20-50): (15-40): (10-40), respectively, and BAA mol % between 0.01 and 0.1; and, (c) synthesizing the polymer P (AA-VP-VIM4C[Br]) with BAA.

16. The process according to claim 13, wherein stage 2 comprises using the formulations of the terpolymers obtained at stage 1 with organic crosslinkers based on: (a) a branched polyethylenimine with intermediate molecular weight at terpolymer/PEI weight ratios equal to 7-15/1; and (b) hexamethylenetetramine (HMTA) and resorcinol (R) at Terpolymer/HMTA/R weight ratios equal to 2.25/1-0.25/2.5-1.50 within a temperature interval ranging from 120° C. to 170° C.

17. The process according to claim 13, wherein stage 3 comprises using tests aimed at blocking fluids and controlling water in a homogeneous or fractured porous medium.
